(19) United States
(12) Patent Application Publication
(10) Pub. No.: US 2012/0106777 A1
(43) Pub. Date: May 3, 2012

(54) SPEAKER DAMPER AND SPEAKER DEVICE

(75) Inventors: Kenta Fujimoto, Tendo-shi (JP); Hiroyuki Kobayashi, Tendo-shi (JP); Shintaro Niidera, Tendo-shi (JP); Hiroyuki Tomiyama, Tendo-shi (JP)

(73) Assignees: TOHOKU PIONEER CORPORATION, Yamagata (JP); PIONEER CORPORATION, Kawasaki-shi, Kanagawa (JP)

(21) Appl. No.: 13/381,318

(22) PCT Filed: Jun. 29, 2009
(86) PCT No.: PCT/JP2009/061883

§ 371 Date: Dec. 28, 2011

(51) Int. Cl. H04R 1/00; H04R 7/26

(52) U.S. Cl. 381/413; 181/166

(57) ABSTRACT

A damper for a speaker for vibratably supporting a voice coil to a static part includes a first damper and a second damper formed in an annular shape having an inner periphery part and an outer periphery part, respectively. The first and second dampers are formed in a shape expandable and contractable in a direction crossing a circumferential direction of the annular shape. The inner periphery part of the second damper is connected to the first damper between the inner periphery part and the outer periphery part of the first damper, and each outer periphery part of the first damper and the second damper is connected to each other such that annular space is formed between the first damper and the second damper.

### FIELD OF THE INVENTION

The present invention relates to a damper for a speaker and a speaker device.

### BACKGROUND OF THE INVENTION

A damper for a speaker is formed as an annular member, a voice coil is connected to the inner periphery side thereof, and the outer periphery side is connected to a static part such as a frame, whereby the static part supports the voice coil. The damper for a speaker supports the voice coil in magnetic space (magnetic gap) of a magnetic circuit. The voice coil is vibratably held in the axis direction when a speaker is driven, and the voice coil is held at a given position in the magnetic space when the speaker is not driven. Further, the damper for a speaker is required to regulate the vibration of the voice coil in one axis direction such that the rolling is restrained, and thus a double damper for double supporting the voice coil is proposed as an effective structure for this purpose (for example, see patent literature 1 described below).

[Patent literature 1] Microfilm of Utility model application 1-109831 (Laid-open utility model publication 3-49000)

The damper for a speaker has an elastically expandable and contractable structure in a direction crossing the circumferential direction of the annular member. Originally, an elastic restoring force of the damper for a speaker is applied in a direction opposite the vibration of the voice coil, whereby a large load is applied in response to the amount of the amplitude of vibration and thus the amplitude of vibration is suppressed. The aforementioned double damper structure has a high restraining effect against the rolling of the voice coil, however the load applied to the amplitude of vibration is doubled compared to that of a single damper, which may unfavorably reduce the driving efficiency of the voice coil.

In order to improve the driving efficiency of a voice coil, the elastic restoring force of the damper for a speaker may be lowered (softened) (may have higher compliance). However, this may cause the rigidity of the connecting part between the damper for a speaker and the static part to decrease, thereby reducing a supporting strength of the damper for a speaker itself, and thus the function of regulating the vibration of the voice coil in one axis direction is deteriorated. Further, since a vibration suppressing force against an excessive amplitude of vibration is not sufficiently obtained, when the voice coil vibrates with an excessive amplitude of vibration, a too much stress is applied to the inner periphery part of the damper that is the connecting part between the damper of a speaker and the voice coil and thus the problems such as the peel-off and the breakage of the damper may occur. In order to regulate the vibration of the voice coil in one axis direction and to suppress an excessive vibration of the voice coil, the rigidity of the damper is required to improve to some extent (low compliance).

Meanwhile, since the displacement of the damper for a speaker does not monotonically increase in accordance with the amplitude of vibration of the voice coil, reproduction with high linearity is difficult to achieve. When the rigidity of the damper for a speaker is increased to some extent, since the compliance of the damper is comparatively small, linearity is decreased even when the voice coil vibrates with comparatively small amplitude of vibration. In order to improve linearity when the voice coil vibrates with comparatively small amplitude of vibration, the compliance of the damper is required to be comparatively large. However, in view of the situation where the voice coil vibrates with comparatively large amplitude of vibration, there is little choice but to improve the rigidity of damper to some extent and decrease the compliance as described above.

### SUMMARY OF THE INVENTION

One or more embodiments of the present invention is provide a damper for a speaker having both high compliance and low compliance, to improve a driving efficiency of the voice coil while regulating the vibration in one axis direction, to obtain a vibration suppressing force against excessive vibration while securing a supporting force of the damper for a speaker, and to restrain the peel-off or breakage of the damper when large amplitude of vibration is applied while enabling reproduction with high linearity in the practical region of the amplitude of vibration.

One or more embodiments of the present invention are provided with the following configurations.

A damper for a speaker that vibratably supports a voice coil to a static part. The damper for a speaker includes a first damper and a second damper. The first damper and the second damper are formed in an annular shape having an inner periphery part and an outer periphery part respectively, the first and second dampers being formed in a shape expandable and contractable in a direction crossing the circumferential direction of the annular shape. The inner periphery part of the second damper is connected to the first damper between the inner periphery part and the outer periphery part of the first damper, and each outer periphery part of the first damper and the second damper is connected to each other such that annular space is formed between the first damper and the second damper. The first damper includes a plurality of expandable and contractable curved parts formed at least from the connecting point of the inner periphery part of the second damper to the inner periphery part of the first damper in a direction crossing the circumferential direction.

### BRIEF DESCRIPTION OF THE DRAWINGS

FIGS. 1(A)-(C) are partial cross-sectional views of a damper for a speaker according to an embodiment of the present invention (partial cross-sectional view illustrating only one side of a center axis O);

FIGS. 2(A), (D), and (E) are views illustrating a variation of a damper for a speaker according to an embodiment of the present invention (partial cross-sectional view);

FIG. 3 is a view illustrating stiffness curves (displacement-force curve) of each example shown in FIGS. 2(A), 2(D) and 2(E);

FIGS. 4(A), (F), and (G) are views illustrating another variation of a damper for a speaker according to an embodiment of the present invention (partially cross-sectional view);

FIG. 5 is a view illustrating stiffness curves (displacement-force curve) of each example shown in FIGS. 4(A), 4(F) and 4(G);

FIGS. 6(A) and (B) are views illustrating another forming example of a damper for a speaker according to an embodiment of the present invention;

FIGS. 7(A)-(D) are views illustrating another forming example of a damper for a speaker according to an embodiment of the present invention;

FIG. 8 is a view illustrating a speaker device equipped with a damper for a speaker according to an embodiment of the present invention (cross-sectional view);

FIG. 9 is a view illustrating a variation of a speaker device equipped with a damper for a speaker according to an embodiment of the present invention (cross-sectional view);

FIG. 10 is a view illustrating a variation of a speaker device equipped with a damper for a speaker according to an embodiment of the present invention (cross-sectional view);

FIG. 11 is a view illustrating a variation of a speaker device equipped with a damper for a speaker according to an embodiment of the present invention (cross-sectional view);

FIG. 12 is a view illustrating a variation of a speaker device equipped with a damper for a speaker according to an embodiment of the present invention (cross-sectional view);

FIGS. 13(A)-(D) are views illustrating a planar shaped example of a damper for a speaker according to an embodiment of the present invention (schematic plan view);

FIG. 14 is a view illustrating an electronic device equipped with a speaker device according to an embodiment of the present invention, and

FIG. 15 is a view illustrating a vehicle equipped with a speaker device according to an embodiment of the present invention.

### DETAILED DESCRIPTION OF THE INVENTION

Hereinafter, embodiments of the present invention are described. The embodiments of the present invention include what are shown in the drawings, but are not limited to only these examples. In the description of the embodiments of the present invention, upper and lower sides are indicative of the sound emission direction and the direction opposite the sound emission direction. A damper (10) for a speaker according to an embodiment of the present invention is a damper for a speaker for vibratably supporting a voice coil to a static part, including a first and a second dampers (11, 12) that are formed in an annular shape having an inner periphery part (11a, 12a) and an outer periphery part (11b, 12b), being formed in an expandable and contractable shape in a direction crossing the circumferential direction of the annular member, and the inner periphery part (12a) of the second damper (12) is connected to the first damper (11) between the inner periphery part (11a) and the outer periphery part (11b) of the first damper (11), and each outer periphery part (11b. 12b) of the first damper (11) and the second damper (12) are connected to each other, whereby annular space (S) is formed between the first damper (11) and the second damper (12), and a plurality of expandable and contractable curved parts (11c) are formed in the first damper (11) at least from the connecting point of the inner periphery part (12a) of the second damper (12) to the inner periphery part (11a) of the first damper (11) in a direction crossing the circumferential direction.

The static part so called here is a collective term of parts that support the vibration by the voice coil. The voice coil or vibrating bodies that are vibrated by the voice coil vibrate relative to the static part. The static part itself is not intended to be completely static here and the entire part of the static part may be vibrated or moved by receiving the effect of the vibration of the voice coil or receiving other forces.

The voice coil is a coil shaped conductive wire through which an audio signal (voice currents) flows and the damper (10) for a speaker supports the voice coil to the static part directly or via other members (voice coil support part and so forth). The damper (10) for a speaker according to an embodiment of the present invention includes the first damper (11) and the second damper (12), however the number of dampers is not limited to two, and three or more dampers may be included. As least the first damper (11) and the second damper (12) are formed in an annular shape, and the inner periphery part (11a, 12a) is formed on the inside thereof and the outer periphery part (11b, 12b) is formed on the outside thereof. Further, the first damper (11) and the second damper (12) are formed in an expandable and contractable shape in a direction crossing the circumferential direction of the annular member. The term of “expandable and contractable” means that the distance from the inner periphery part to the outer periphery part of the damper become large or small, including the deformation of the damper. Further, the expandable and contractable shape includes a so-called corrugation shape. The vibration of the voice coil causes the first damper (11) and the second damper (12) to expand and contract, thereby allowing the voice coil to vibrate.

The inner periphery part (12a) of the second damper (12) is connected to the part between the inner periphery part (11a) and the outer periphery part (11b) of the first damper (11). Further, the outer periphery part (11b) of the first damper (11) and the outer periphery part (12b) of the second damper (12) are connected to each other. At this point, the annular space is formed between the first damper (11) and the second damper (12) such that both dampers do not closely contact with each other as a whole, and each damper is configured to be independently expandable and contractable. As such, when the first damper (11) mainly acts, the second damper (12) has little effect on the action.

And, a plurality of expandable and contractable curved parts (11c) are formed at the first damper (11) at least from the connecting point of the inner periphery part (12a) of the second damper (12) to the inner periphery part (11a) of the first damper (11) in a direction crossing the circumferential direction. That is, the first damper (11) can be configured to obtain a structure with large compliance, having a plurality of curved parts (11c) formed on the inner side portion thereof, which receives little effect from the second damper (12).

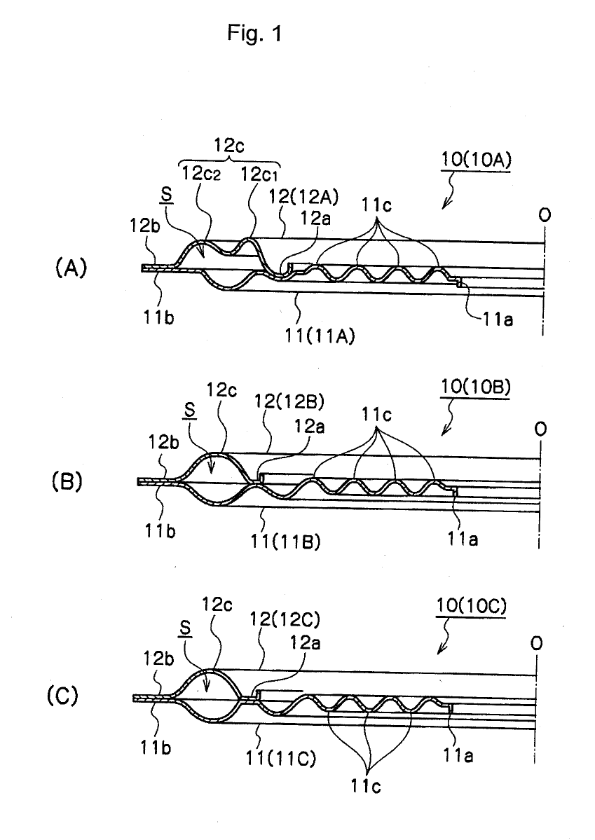

Hereinafter, a configuration example of a damper for a speaker according to an embodiment of the present invention is described with reference to the drawing. FIG. 1 is a partially cross-sectional view of the damper for a speaker according to an embodiment of the present invention (partially cross-sectional view illustrating only one side of a center axis O). In examples shown in FIGS. 1(A), 1(B), 1(C), dampers (10A, 10B, 10C) for a speaker include the first dampers 11 (11A, 11B, 11C) and the second dampers 12 (12A, 12B, 12C). The first damper 11 and the second damper 12 are annularly formed members. The inner periphery part 11a of the first damper 11 is supported on the voice coil side, while the outer periphery part 11b is supported on the static part side. The inner periphery part 12a of the second damper 12 is connected to the part between the inner periphery part 11a and the outer periphery part 11b of the first damper 11, and the outer periphery part 12b is connected to the outer periphery part 11b of the first damper 11 directly or via other members (adhesive and so forth). Further the annular space S is formed between the first damper 11 and the second damper 12, and the first damper 11 and the second damper 12 are configured to be individually expandable and contractable except the portions of the first damper 11 and the second damper 12 that are connected. Further, a plurality of curved parts 11c are formed on the first damper 11 at least from the connecting point of the inner periphery part 12a of the second damper 12 to the inner periphery part 11a of the first damper 11. The curved parts 11c are configured to be expandable and contractable in a direction crossing the circumferential direction of the first damper 11.

In each example shown in FIGS. 1(A), 1(B), 1(C), the second damper 12A in the example shown in FIG. 1(A) has a plurality of curved parts 12c (12c₁,12c₂), and the second dampers 12B, 12C in the examples shown in FIG. 1(B), 1(C) have a single curved part 12c. Further, in the example shown in FIG. 1(A), the inner periphery part 12a of the second damper 12A is connected in the recessed part of the first damper 11A, and in the example shown in FIG. 1(B), the inner periphery part 12a of the second damper 12B is connected in the protruding part of the first damper 11B. In the example shown in FIG. 1(C), the inner periphery part 12a of the second damper 12C is connected on the flat part of the first damper 11C.

In the aforementioned description, the curved part means a part which has a cross-section formed in an arc shape or corrugation shape. A plurality of curved parts means a part which has a cross-section having a plurality of curved top parts. Further, the curved parts are formed in substantially similar shape in the circumferential direction of the annular member, and are formed in substantially similar curved shape or corrugation shape anywhere in the cross-section in a direction orthogonal to the circumferential direction.

Another example of the curved part having a curved top part includes, for example, a V-shape curved part constituted by two linear portions and a curved top part that is formed by crossing the two linear portions. Further in the example shown in the drawing, the curved top part is provided in the proximity of the center position of the curved part. However the curved top part may be provided at the position displaced toward the inner periphery side or the outer periphery side with respect to the center position. Moreover, it is only necessary that the curved part is formed in a mountain like shape, for example, the curved top part may be formed in a flat shape as is the flat part of the first damper 11C shown in FIG. 1(C).

The damper 10 for a speaker includes the first damper 11 on the side of the inner periphery part and the second damper 12 on the side of outer periphery part with the connecting point as a boundary between the inner periphery part of the second damper 12 and the first damper 11, and the first damper 11 is configured to be more flexible and movable (higher compliance) whereas the second damper 12 is configured to have higher rigidity (lower compliance) than the first damper 11, whereby an effective function can be obtained as described below.

According to this configuration, the flexible first damper 11 on the inner periphery side mainly moves in the practical amplitude of vibration (for example, the amplitude of vibration of the voice coil is comparatively small in the use of the reproduction of music with a normal sound volume) and the second damper 12 assists the support of the first damper 11 from the outer periphery side. In this case, the displacement of the first damper 11 is monotonically increased within the practical amplitude of vibration in response to the vibration of the voice coil, whereby reproduction with high linearity can be achieved.

Further, when the vibration of the voice coil enters into the domain of the greater amplitude of vibration beyond the domain of the practical amplitude of vibration, for example, in response to large voice currents being inputted to a speaker, the first damper 11 on the inner periphery side starts to produce tension (starts to extend completely), and thereby the second damper 12 on the outer periphery side starts to move gradually. Within the domain of this greater amplitude of vibration, linearity is reduced while the second damper 12 with low compliance functions such that the braking against an excessive vibration is applied to the voice coil to restrain damages (peel-off, breakage, etc.) of the connecting point between the outer periphery parts 11b, 12b of the first damper 11 and the second damper 12, and the static part. Also, in the sound quality, a saturated feeling in audibility can be alleviated (soft distortion).

As such, the damper a speaker 10 can be configured such that the inner periphery side is flexible by the first damper 11 while the outer periphery side is reinforced by the second damper 12, and therefore the voice coil can be vibrated at high efficiency of vibration with high linearity within a practical amplitude range of vibration while the tension applied to the first damper is reduced by the function of the second damper 12 with low compliance with respect to the greater amplitude of vibration in response to the greatest voice currents being inputted, in other words, the acceleration of the first damper is prevented from being comparatively large. That is, the damper 10 for a speaker can have both high compliance to improve linearity and high input resistance. In the conventional damper, if high compliance is pursued to improve linearity, resistance strength when the greater amplitude of vibration is applied is reduced, and thus high input resistance cannot be obtained.

Further, as a feature of the damper 10 for a speaker, the second damper 12 is connected only on the outer periphery side of the first damper 11 to reinforce the first damper 11. When the voice currents become large such that the amplitude of vibration of the voice coil becomes large, the second damper 12 with low compliance connected to the outer periphery side starts to extend gradually after the first damper 11 with high compliance that is on the inner periphery side completely extends, and thus the impact on the connecting part between the damper 10 and the voice coil (or voice coil support part) or the connecting part between the damper 10 for a speaker and the static part due to a dramatic change in acceleration can be alleviated. As such, the mechanical fatigue applied on the aforementioned connecting part can be restrained.

Further, the damper 10 for a speaker is configured such that the inner periphery part 12a of the second damper 12 is connected to the first damper 11 between the inner periphery part 11a and the outer periphery part 11b of the first damper 11 and each of the outer periphery parts 11b, 12b of the first damper 11 and the second damper 12 is connected to each other such that the annularly shaped space S is formed between the first damper 11 and the second damper 12. As such, the annular space S improves the torsional rigidity of the damper 10 for a speaker and thus the capability of regulating the vibration of the voice coil in one axis direction can be strengthened and the rolling of the voice coil and so forth can be restrained. As such both the improvement of driving efficiency due to the first damper 11 with high compliance and the regulation of the vibration of the voice coil in one axis direction can be achieved.

Further the annular space S may or may not be a sealed space to the outside. In order to form the annular space S that is not sealed to the outside, for example, the first damper 11 and the second damper 12 are formed with a member that has a ventilation characteristic or a vent hole is formed in a part of the first damper 11 or the second damper 12 such that the annular S is communicated with the outside.

The shape of the first damper 11 is formed such that a plurality of expandable and contractable curved parts 11c are provided at least from the connecting point of the inner periphery part 12a of the second damper 12 to the inner periphery part 11a of the first damper 11 in a direction crossing the circumferential direction, whereby higher compliance can be easily achieved. The first damper 11 is continuously formed with one member from the inner periphery side 11a to the outer periphery side 11b, whereby manufacturing becomes easier with simple structure and at low cost. The first damper 11 can adopt the shape of the conventional high compliance damper as is.

On the one hand, the second damper 12 is required to have a damper function expandable and contractable in a direction crossing the circumferential direction of the annular member. As such the configuration and function are different from a damper in which a rigid reinforcing material that is unexpandable and uncontractable is connected on the outer peripheral side. The second damper 12 has an expandable and contractable function in a direction crossing the circumferential direction of the annular member, whereby a damper function is gradually effected with the magnitude of the vibration of the voice coil and braking in the greater amplitude of vibration is gradually effected, and thus the aforementioned soft distortion can be obtained.

The second damper 12 may have a shape such that a plurality of expandable and contractable curved parts 12c (12c₁,12c₂) are formed in a direction crossing the circumferential direction of the annular member as shown in FIG. 1(A), or may have a shape such that a single curved part 12c is formed as shown in FIGS. 1 (B), 1(C). In this case, the cross-section of the second damper 12 is formed in a protruding shape with the top part projecting from the inner periphery part 12a and the outer periphery part 12b, and according to an example shown in FIG. 1A, the cross-section of the second damper 12 includes a plurality of the aforementioned tops in the cross-sectional shape. As described above, the second damper 12 has one advantage with the property of low compliance. Also, when a plurality of curved parts 12c (12c₁,12c₂) are formed as shown in FIG. 1(A), the deformable length (valid length) of the second damper 12 can be comparatively large in comparison with the examples shown in FIGS. 1(B), 1(C), forming a single curved part 12c. As such, when the voice coil vibrates with the comparatively large amplitude of vibration, the tension applied to the first damper is reduced as well as the tension applied to the second damper is reduced. Further, a plurality of the curved pars 12c (12c₁,12c₂) the second damper 12 has are formed such that the curvature diameter of the curved part 12c₂ on the outer periphery side is larger than the curvature diameter of the curved part 12c₁ on the inner periphery side, whereby the valid effective length can be comparatively large.

Further, in the second damper 12, the curvature diameter of the curved part 12c₂ on the outer periphery side is formed so as to be larger than the curvature diameter of the curved part 12c₁ on the inner periphery side, whereby the compliance on the outermore periphery side can be large, and as such, the magnitude relation can be arbitrarily adjusted between the compliance on the outer periphery side and the compliance on the inner periphery side.

Further, the outer periphery part of the first damper 11 which forms the annular space S with the second damper 12 becomes the part which does not require high compliance by being connected to the second damper 12. As such also in the first damper 11, a plurality of curved parts 11c is formed such that the curvature diameter of the curved part on the outer periphery side is larger than the curvature diameter of the curved part on the inner periphery side by changing one curvature part 11c, whereby the compliance on the outermore periphery side can be improved.

The inner periphery part 12a of the second damper 12 is formed along the surface profile of the first damper 11. As such, the inner periphery part 12a of the damper 12 can be in contact with and connected to the middle portion (a part) of the first damper 11 that has curved parts 11c. Further, the inner periphery part 12a of the damper 12 is in contact with the middle portion (a part) of the first damper 11, whereby the first damper 11 operates simultaneously with the second damper 12 in the connecting part, thereby following the vibration of the voice coil. Further, the middle portion of the first damper 11 and the inner periphery part 12a of the second damper 12 are formed substantially in the same shape, whereby a stress can be uniformly applied to the entire connecting part, thus the occurrence of peel-off and so on can be restrained. In the examples shown in FIGS. 1(A), 1(B), the inner periphery part 12a of the second dampers 12A, 12B is formed in a curved shape and is connected onto the curved part 11c of the first damper 11. In the examples shown in FIG. 1(C), the inner periphery part 12a of the second damper 12C is formed to be flat and is connected onto the flat part of the first damper 11.

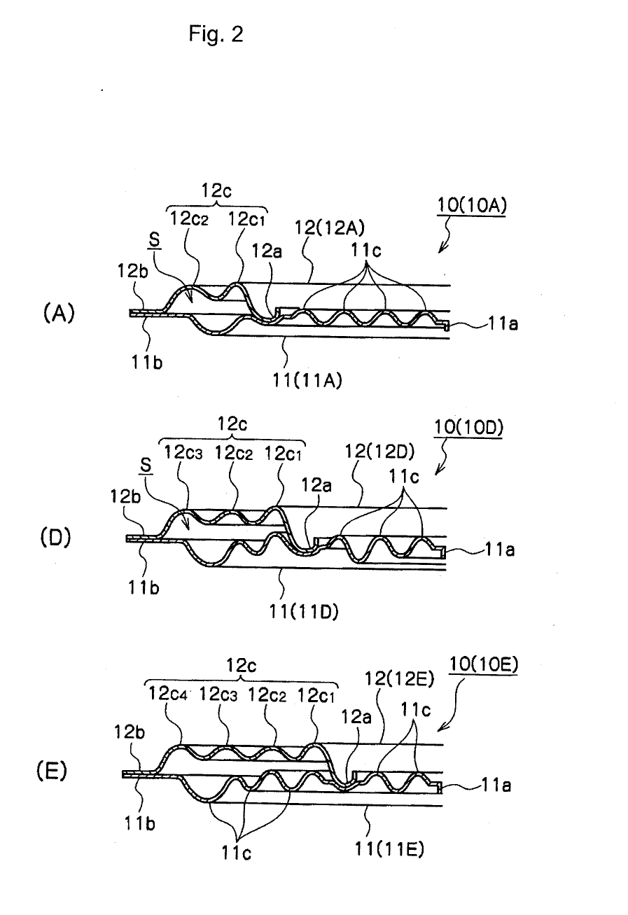

FIG. 2 is a view illustrating a variation of a dampers (10A, 10D, 10E) for a speaker according to an embodiment of the present invention (partial cross-sectional view) (The same symbols are applied to the parts in common with the aforementioned embodiment and the descriptions are partially omitted). The example shown in FIG. 2(A) is the same as the example shown in FIG. 1(A). In the example shown in FIG. 2(D), the inner periphery part 12a of the second damper 12 (12D) is located at the position on the side of the inner periphery part 11a of the first damper 11 more than the example shown in FIG. 2(A). In the example shown in FIG. 2(E), the inner periphery part 12a of the second damper 12 (12E) is located at the position further on the side of the inner periphery part 11a of the first damper 11 more than the example shown in FIG. 2(D). In the example shown in FIG. 2(D), the inner periphery part 12a of the second damper 12 is connected near the center between the inner periphery part 11a and the outer periphery part 11b of the first damper 11. In the example shown in FIG. 2(E), the inner periphery part 12a of the second damper 12 is connected on the side of the inner periphery part 11a more than the center position between the inner periphery part 11a and the outer periphery part 11b of the first damper 11. Further, in the example shown in FIG. 2(A), the inner periphery part 12a of the second damper 12 is connected on the side of the outer periphery part 11b more than the center position between the inner periphery part 11a and the outer periphery part 11b of the first damper 11.

As shown in each example in FIG. 2, the location where the inner periphery part 12a of the second damper 12 is connected to the first damper 11 is changed, whereby the performance (stiffness curve) of the damper 10 for a speaker can be adjusted. The inner periphery part 12a of the second damper 12 is connected on the side of the outer periphery part 11b more than the center position between the inner periphery part 11a and the outer periphery part 11b of the first damper 11, whereby the characteristic of the first damper 11 can be significantly extracted. As such, the linearity in the practical amplitude of vibration becomes comparatively high, and thereby the range of the amplitude of vibration of the voice coil can be large. Further, by increasing the compliance of the first damper 11, the linearity in the practical amplitude of vibration becomes comparatively high, whereby the range of the amplitude of vibration of the voice coil can be large. The inner periphery part 12a of the second damper 12 is connected on the side of the inner periphery part 11a more than the center position between the inner periphery part 11a and the outer periphery part 11b of the first damper 11, whereby the second damper 12 is extended even when the vibration of the voice coil is not so large, and thus the low compliance of the second damper 12 can be gradually effected on the entire damper 10 with the improve in the amplitude of vibration of the voice coil.

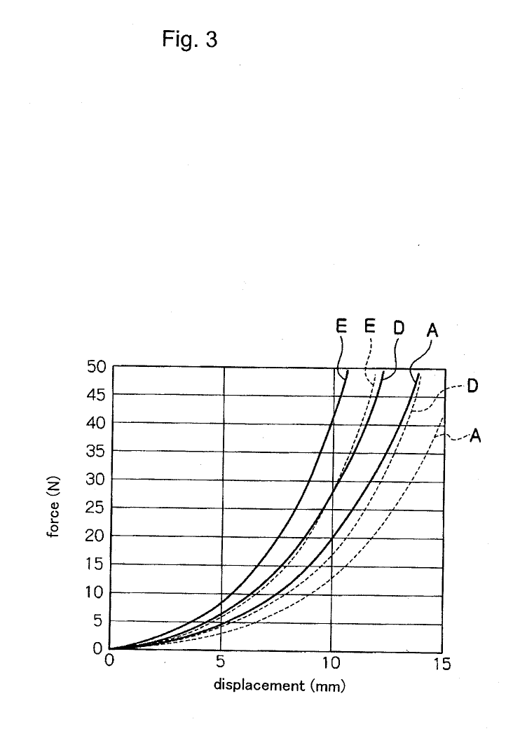

FIG. 3 is a view illustrating stiffness curves (displacement-force curve) of each example shown in FIGS. 2(A), 2(D), and 2(E) (a solid line indicates the upper amplitude of vibration, a broken line indicates the lower amplitude of vibration, a force is an absolute value of force for expanding and contracting a damper 10 for a speaker, a displacement is the absolute value of displacement in the inner periphery part 11a of a damper 10 for speaker in the vibration direction of the voice coil). As the connecting position between the inner periphery part 12a of the second damper 12 and the first damper 11 is shifted closer to the inner periphery side (voice coil side) (in order of FIGS. 2(A), 2(D) and 2(E)), the curve shown in the diagram gets more precipitous. For example, if the domain of low compliance is considered 20N or higher, the amplitude of vibration (displacement) to reach the domain of low compliance becomes longer in order of FIGS. 2(E), 2(D) and 2(A). That is, the connecting position between the inner periphery part 12a of the second damper 12 and the first damper 11 is adjusted nearer to the inner periphery or nearer to the outer periphery, whereby the amplitude of vibration entering into the domain of low compliance can be easily set. If the aforementioned connecting position is shifted toward the inner periphery side (voice coil side) the amplitude of vibration entering into the domain of low compliance can become low, and if the connecting position is shifted toward the outer periphery side (static part side), the amplitude of vibration entering into low compliance can become large. The amplitude of vibration entering into the domain of low compliance can be low, thereby a dramatic change in stress can be more alleviated, and thus the stress applied to the adhesive part between the outer periphery part of a damper 10 for a speaker and the static part (frame and so on) can be more reduced.

Further, the hardness of the first damper 11 and the second damper 12 is adjusted in accordance with the aforementioned connecting position, whereby the inflection point of stiffness curve in small input (when the amplitude of vibration of the voice coil is small) and in large input (when the amplitude of vibration of the voice coil is large) can be arbitrarily set. If the compliance of the first damper 11 is set higher (flexibility is high), the linearity in small input can be improved, and if the aforementioned connecting position is shifted more outer side such that the valid length of the first damper 11 is high, the driving domain where compliance is large (move flexibly) can be extended.

In each example of FIGS. 2(A), 2(D) and 2(E), the second damper 12 is provided with a plurality of curved parts 12c respectively, and in each example, as the connecting position between the inner periphery part 12a of the second damper 12 and the first damper 11 is shifted more on the inner periphery side, the number of the curved parts 12c is increased. Two curved parts 12c (12c₁,12c₂) are provided in an example shown in FIG. 2(A), three curved parts 12c (12c₁, 12c₂, 12c₃) are provided in an example shown in FIG. 2(D), and four curved parts 12c (12c₁, 12c₂, 12c₃, 12c₄) are provided in an example shown in FIG. 2(E). The number of curved parts 12c of the second damper 12 is effectively allocated in accordance with the width of the second damper 12 in order to maintain the stretching property when the width of the second damper 12 is large, and the valid length of the second damper 12 can be arbitrarily adjusted.

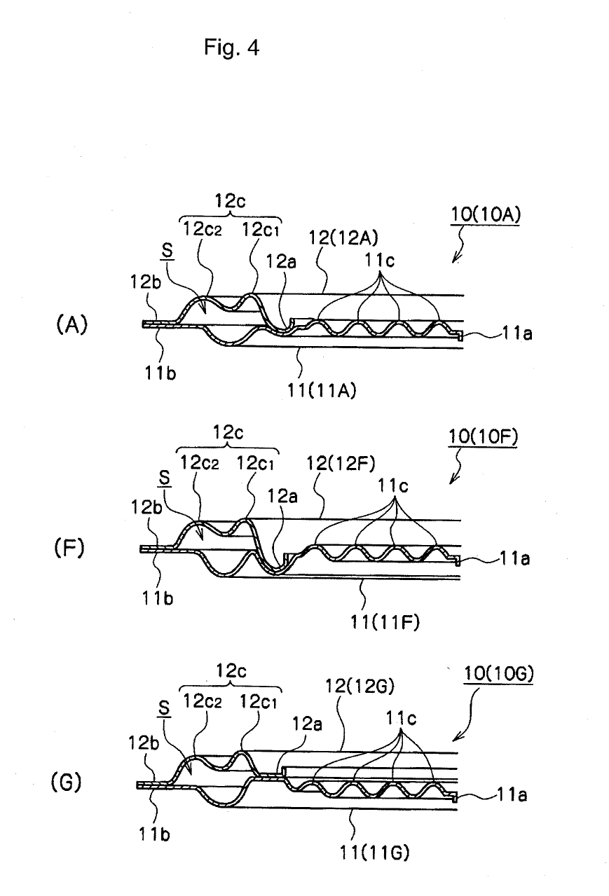

FIG. 4 is a view illustrating another variation of a dampers 10 for a speaker (10A, 10F, 10G) according to an embodiment of the present invention (partially cross-sectional view) (The same symbols are applied to the parts in common with the aforementioned embodiment and the descriptions are partially omitted). The example shown in FIG. 4(A) is the same as the example shown in FIGS. 1(A) and 2(A). In the example shown in FIG. 4(F), the inner periphery part 12a of the second damper 12 (12F) is located on the side opposite the curved projecting side of the second damper 12 (12F) with respect to the outer periphery part 12b of the second damper 12 (12F) in comparison with the example shown in FIG. 4(A). In the example shown in FIG. 4(G), the inner periphery part 12a of the second damper 12 (12G) is located on the side of the curved projecting side of the second damper 12 (12G) with respect to the outer periphery part 12b of the second damper 12 (12G) in comparison with the example shown in FIG. 4(A).

As shown in each example in FIG. 4, the vertical position of the inner periphery part 12a of the second damper 12 is changed, whereby the performance (symmetric property of vertical vibration in stiffness) of the damper 10 for a speaker can be adjusted. Here, the term “symmetric property of vertical vibration in stiffness” means a symmetrical property between the stiffness curve when the voice coil vibrates upwardly and the stiffness curve when the voice coil vibrates downwardly.

The symmetric property of vertical vibration in stiffness is improved if the position of the inner periphery part 12a of the second damper 12 is shifted upwardly (on the curved projecting side of the second damper 12) under the assumption that the second damper 12 is connected on the upper side of the first damper 11, projecting upwardly. The asymmetric property of vertical vibration in stiffness (asymmetrical property between the stiffness curve when the voice coil vibrates upwardly and the stiffness curve when the voice coil vibrates downwardly) becomes large if the position of the inner periphery part 12a of the second damper 12 is shifted downwardly (opposite the curved projecting side of the second damper 12).

The damper 10 for a speaker has asymmetrical property normally in a vertical action, however if the structure of the second damper 12 is adjusted by adopting the structure of joining two different shaped dampers (the first damper 11 and the second damper 12) such that a braking force is applied in a direction the first damper 11 excessively extends on the basis of a specific characteristic of the first damper 11 as a single formed item, the asymmetrical property of vertical vibration in stiffness can be improved. For example, as shown in FIG. 4(G), the position of the second inner periphery part 12a of the second damper 12 connected the first damper 11 is shifted upwardly over the top of the curved part 11c of the first damper 11 (on the sound emission side), whereby the vibration of the voice coil with high symmetrical property of vertical vibration in stiffness can be obtained.

On the contrary, by using the asymmetrical property of vertical vibration in stiffness the lower side vibration of the voice coil is suppressed, thereby a bottom hit against a yoke and so forth of a magnetic circuit due to the lower amplitude of vibration of the voice coil can be restrained. As shown in the examples in FIGS. 4(A), 4(F), the position of the inner periphery part 12a of the second damper 12 connected to the first damper 11 is set to be substantially the same or lower than the top of the curved part 11c of the first damper 11, whereby the downward amplitude of vibration can be restrained. This configuration is suitable when large downward amplitude of vibration cannot be secured for a structural reason and so forth.

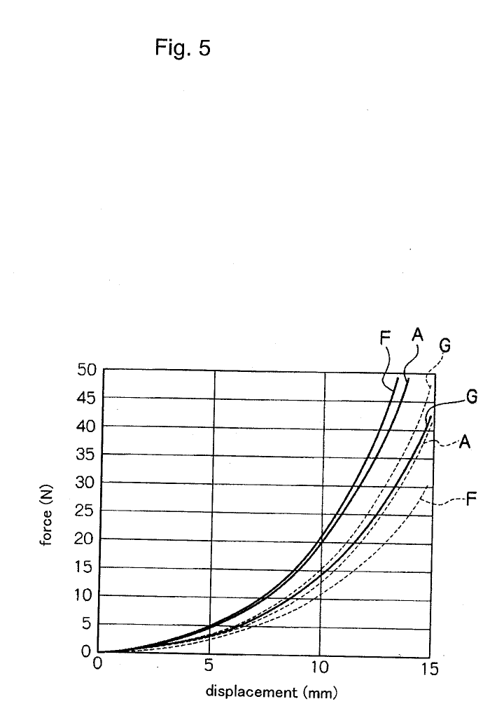

FIG. 5 is a view illustrating stiffness curves (displacement-force curve) of each example shown in FIGS. 4(A), 4(F), and 4(G) (a solid line indicates the upper amplitude of vibration, a broken line indicates the lower amplitude of vibration, a force is an absolute value of force for expanding and contracting a damper 10 for a speaker, a displacement is the absolute value of displacement in the inner periphery part 11a of a damper 10 for a speaker in the vibration direction of the voice coil.) As described above, in an example shown in FIG. 4(G), the solid curved line and a broken curved line are proximate to each other, and thus the symmetrical property in stiffness is obtained. In contrast, in the examples shown in FIGS. 4(A), 4(F), the solid curve line and the broken curve line are apart each other, and thus the asymmetrical property in stiffness is obtained. Particularly in the example shown in FIG. 4(F), the broken line (downward vibration) is significantly apart from the solid line (upward vibration), and thus the lower side of the amplitude of vibration of the voice coil can be restrained.

The material of the damper 10 for a speaker is now described. Since the damper 10 for a speaker is configured such that the second damper 12 supports the first damper 11, the mass of the first damper 11 substantially has a large contribution on the equivalent mass of a vibration system when the voice coil vibrates with a comparatively small amplitude of vibration (within the domain of the practical amplitude of vibration). In order to form the first damper 11 having a high compliance, the first damper 11 is preferably formed with a member having comparatively small density with pores formed therein, such as a fiber system member including a cloth having, for example, unwoven fabric or woven fabric that are composed of fiber. Further, as unwoven fabric used for the fiber system member (cloth), for example, what has comparatively large area density with comparative large number of punching by a needle punch or what is composed of fiber with comparatively small diameter and so forth can be preferably used. Further, as woven fabric of a fiber system member (cloth), what is composed with fiber having comparatively small diameter can be preferably used. By using such a first damper, a flexible damper with comparatively high compliance can be obtained.

When both the first damper and the second damper are formed with fibrous member, the diameter of the fiber forming the second damper 12 is formed to be larger than the diameter of the fiber forming the first damper 11, whereby the difference in compliance between the first damper 11 and the second damper 12 can be obtained such that the compliance of the second damper 12 is smaller than the compliance of the first damper. Further, when both the first damper 11 and the second damper 12 are formed with fibrous member, the area density of the fiber forming the second damper 12 is formed to be higher than the area density of the fiber forming the first damper 11, whereby the difference in compliance between the first damper 11 and the second damper 12 can be obtained such that, for example, the compliance of the second damper 12 is smaller than the compliance of the first damper.

Further, in order to improve the rigidity of the second damper 12, the rigidity of the fiber itself that forms the second damper 12 is improved by using a cloth composed of thick thread and a plurality of fibers is restrained by adhesive resin. As such the restoring force and rigidity of the second damper is improved.

In this case, the mass of the second damper 12 is comparatively large by the applied adhesive resin, however the mass increase has little effect on the equivalent mass of vibration system of a speaker within the domain of the practical amplitude of vibration, thereby causing little adverse effect such as the reduction of sensitivity (the ratio of output sound pressure to voice currents is reduced). Further, by restraining the fiber with the adhesive resin, the second damper 12 is provided with a restoring force and rupture strength while the rigidity of the adhesive resin is applied to the second damper 12, and thereby the rigidity of the second damper 12 is comparatively large. Further, the elastic force of the adhesive resin can comparatively improve the restoring force of the second damper 12 as well. By selecting the type of the adhesive resin, desired elasticity or rigidity can be applied to the second damper 12. Specifically, by impregnating a cloth with thermostatic resin such as phenol resin and adjusting the impregnated specific gravity, the elasticity or the rigidity applied to the second damper 12 can be adjusted. Further, the physical property of the second damper 12 can be adjusted, which includes adjusting the internal loss of the second damper 12 with the slip between fibers or the internal loss of the adhesive resin, hardening the adhesive resin and at the same time improving the rigidity of the second damper 12 by pressing the cloth with a heated pressing member, and so forth.

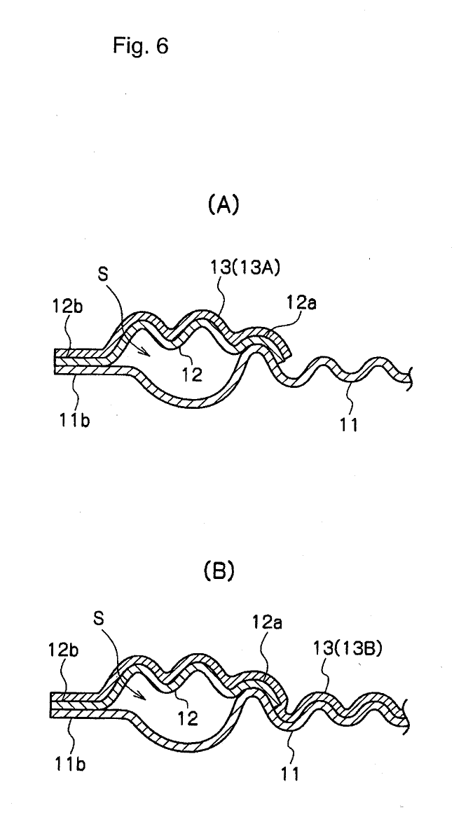

FIG. 6 is a view illustrating another forming example of the damper 10 for a speaker (the same symbols are applied to the parts in common with the aforementioned embodiment and the descriptions are partially omitted). In the example shown here, a resin layer 13 is continuously formed in the proximity of the surface of the second damper 12. And, in the example shown in FIG. 6(A), the resin layer 13 (13A) is formed only on the second damper 12, while in the example shown in FIG. 6(B), the resin layer 13 (13B) is continuously formed from the second damper 12 to the first damper 11. Further in this example, the resin layer 13 (13A) covers the connecting part (the inner periphery part 12a of the second damper 12) between the second damper 12 and the first damper 11. Further the connecting part is formed in a curved shape.

The resin layer 13 is continuously formed in the proximity of the surface of the second damper 12, desired elasticity (Young's modulus) and internal loss can be applied to the second damper 12 in accordance with a physical characteristic of the resin layer 13. Further, depending on the selected material of the resin layer 13, the rigidity that is higher than the rigidity of the selected cloth material of the second damper 12 can be applied to the second damper 12. When the resin layer 13 is formed only on the second damper 12, the vibration characteristic (for example, the aforementioned stiffness characteristic) can be improved when the second damper 12 expands and contracts in response to the large amplitude of vibration (large input) of the voice coil. Further, the resin layer 13 is continuously formed from the second damper 12 to the first damper 11, the vibration characteristic of the entire damper 10 for a speaker can be improved even in a shifting range of the amplitude of vibration of the voice coil shifting from the small amplitude of vibration (small input) to the large amplitude of vibration (large input). Particularly, by covering the connecting part between the first damper 11 and the second damper 12 with the resin layer 13, the connecting strength of the connecting part can be improved.

Further, when the fiber forming the second damper 12 is restrained by the adhesive resin, another resin layer 13 can be formed in the proximity of the surface of the second damper 12. In this case, the adhesive resin is preferably selected mainly so as to serve to adjust elasticity (Young's modulus) and the resin layer 13 that is formed in the proximity of the surface is preferably selected so as to serve to adjust the internal loss. At this point, the resin layer 13 is selected such that the internal loss of the resin material forming the resin layer 13 is larger than the internal loss of the aforementioned adhesive resin. By adopting the resin layer 13 that has higher internal loss, the unwanted vibration in the damper 10 for a speaker can be restrained, and thus a rolling phenomenon and so forth generating in the voice coil can be restrained. Further, it is possible to restrain the vibration of the voice coil from being transmitted to a frame or diaphragm that are described later via the damper 10 for a speaker, causing abnormal noise and harmonic distortion due to the unwanted vibration.

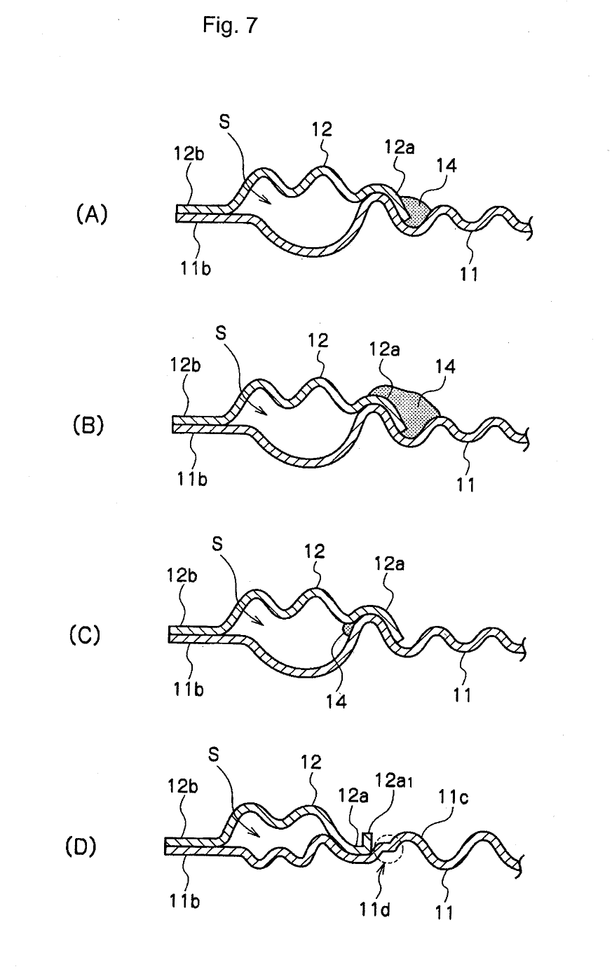

FIG. 7 is a view illustrating another forming example of a damper for a speaker (The same symbols are applied to the parts in common with the aforementioned embodiment and the descriptions are partially omitted). Here, the drawing illustrates an example of reinforcing the connecting part between the inner periphery part 12a of the damper 12 and the first damper 11. The inner periphery part 12a of the second damper 12 can be coupled with the surface of the first damper 11 by means of an adhesive 14. The adhesive 14 can have reinforcing or braking capability. In the example shown in FIG. 7(A), the inner periphery part 12a of the second damper 12 is faced to the recessed part of the curved part of the first damper 11, and the connecting part is reinforced by filling inside the recessed part with the adhesive 14. In the example shown in FIG. 7(B), similarly the inner periphery part 12a of the second damper 12 is faced to the recessed part of the curved part of the first damper 11 and the inside of the recessed part is filled with the adhesive 14, however the adhesive 14 further covers the inner periphery part 12a of the second damper 12. In the example shown in FIG. 7(C), the adhesive 14 is interposed between the inner periphery part 12a and the upper surface of the first damper 11 at the lead end and the tail end of the inner periphery part 12a of the second damper 12.

In the example shown in FIG. 7(D), the first damper 11 has a step 11d in the proximity of the connecting part where the damper 11 and the second damper 12 are connected to each other. Further, the step 11d preferably has a planar shape with rigidity. Bending rigidity is added to a part of the damper 10 for a speaker in the proximity of the connecting part by means of the step 11d, in other words, the deformation can be restrained. As such, the connection between the first damper 11 and the second damper 12 can be restrained from being disengaged by the deformation of the connecting part due to the vibration of the voice coil, and thereby the coupling strength of the connecting part can be maintained for a long term. Further the inner periphery part 12a of the second damper 12 is formed in a folding-back shape toward the sound emission direction (folding back part 12a₁). The positioning between the first damper 11 and the second damper 12 is performed by the step 11d of the first damper 11 and the folding back part 12a₁ of the second damper 12 and the folding back part 12a₁ serves as a reinforcing rib, thereby reinforcing the connecting part.

A speaker wire (not shown) for inputting an audio signal from the outside to the voice coil 30 may be placed in the space surrounded by the damper 10 and the diaphragm 3. At this point by lowering the height of the curved part of the outer periphery side to be lower than the height of the curved part of the inner periphery side, for example as is the damper 10 shown in FIG. 7(D), a comparatively large gap can be provided between the speaker wire and the damper 10 or the diaphragm 3. As such, the contact between the speaker wire and the damper 10 or the diaphragm 3 can be restrained.

Further, the aforementioned second damper includes a plurality of curved parts while including a single curved part with a large curvature diameter, and it can also be said that the single curved part includes a plurality of curved parts with a small curvature diameter. The virtual curved top part of the curved part with a large curvature diameter is provide on the upper side position of the curved top part of the curved part with a small curvature diameter, for example in FIG. 1(A). The second damper 12 includes such a curved part, whereby the compliance can be comparatively decreased while the valid length can be comparatively extended. The second dampers shown in FIG. 1(B), FIG. 1(C), FIG. 2(D), FIG. 2(E), FIG. 4(F), FIG. 4(G), FIG. 6 and FIG. 7 are similarly described.

Further, the second damper having a plurality of curved parts with a large curvature diameter may be used without being limited to the aforementioned second damper, and thus it is possible to arbitrarily change as necessary.

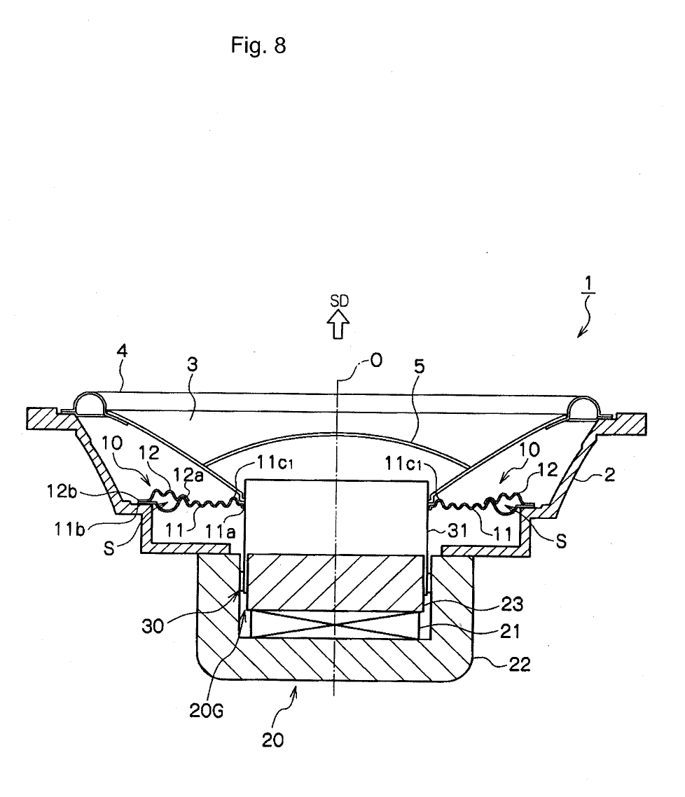

FIG. 8 is a view illustrating a speaker device equipped with a damper for a speaker according to an embodiment of the present invention (cross-sectional view). The speaker device 1 includes the aforementioned damper 10 for a speaker, the static part including a magnetic circuit 20, and a vibrating body which includes the voice coil 30 and is supported by the aforementioned static part. In the example shown in the drawing, the static part includes a frame 2 for supporting the magnetic circuit in addition to this magnetic circuit 20. Further, the vibrating body includes the aforementioned voice coil 30, a voice coil support part (voice coil bobbin) 31 supporting the voice coil 30, a diaphragm 3 with the inner periphery part being supported by the voice coil support part 31 (or the voice coil 30), and an edge 4 for supporting the outer periphery part of the diaphragm 3 to the frame 2 that is the static part. In the example shown in the drawing, the diaphragm 3 is formed in a cone shape, the outer surface of the voice coil support part 31 is connected to the center opening and a dust-proof cap 5 is attached so as to cover the opening.

In the example shown in the drawing, the magnetic circuit 20 includes a magnet 21, a yoke 22, and a plate 23. A magnetic gap 20G is formed such that the voice coil 30 is arranged between the inner surface of the yoke 22 and the outer surface of the plate 23, and the magnetic gap 20G forms magnetic space constituted by magnetic field lines crossing the conductive wire of the voice coil 30. The example shown in the drawing illustrates a so-called inner magnet type magnetic circuit, however the type of the magnetic circuit 20 is not specifically limited an inner magnet type and it may be an outer magnet type or a both magnet type consists of an inner magnet and an outer magnet.

As described above, the damper 10 for a speaker includes the first damper 11 and the second damper 12, and the inner periphery part is connected to the voice coil support part 31 (or voice coil 30) and the outer periphery part is supported by a frame 2 that is the static part. More specifically, the inner periphery part 11a of the first damper 11 of the damper 10 for a speaker is coupled to the outer surface of the voice coil support part 31, and the connecting part between the outer periphery part 11b of the first damper 11 and the outer periphery part 12b of the damper 12 is coupled to the frame 2.

In such a speaker device 1, when an audio signal is inputted into the voice coil 30, the voice coil 30 vibrates along the center axis O and thereby vibrating the voice coil support part 31 supported by the damper 10 for a speaker. Thus, the diaphragm 3 and the edge 4 vibrate thereby emitting sound toward the sound emission direction SD.

As described above, in the speaker device 1, the damper 10 for a speaker includes the first damper 11 which is formed to have high compliance and the second damper 12 which is formed to have low compliance. When the voice coil vibrates within the domain of the practical amplitude of vibration in response to a small input (when small voice currents are inputted), the speaker device 1 operates with the high compliance of the first damper 11. When the voice coil vibrates with large amplitude of vibration beyond the domain of the practical amplitude of vibration in response to a large input (when large voice currents are inputted), the speaker device 1 operates with the low compliance by synthesizing the compliances of the second damper 12 and the first damper 11.

As such, reproduction with high linearity can be achieved within the domain of the practical amplitude of vibration where the first damper 11 mainly acts, and when the large amplitude of vibration beyond the practical amplitude of vibration is applied, the second damper 12 is gradually effected to apply a suitable braking on the large amplitude of vibration, and thus high input resistance can be obtained. Further, the torsional rigidity of the damper 10 for a speaker is improved by the annular space S that is formed as a part of the first damper 11 and the second damper 12, whereby the vibration of the voice coil 30 can be suitably regulated in one axis direction against the rolling of the voice coil 30 and so forth. Thus, the sound quality can be improved compared to an input resistance speaker at the same level by improving the linearity, and the reliability can be improved compared to a high compliance speaker at the same level by restraining the damage and the rolling when large amplitude of vibration is inputted.

Further, in the damper 10 for a speaker, both the outer periphery part 11b of the first damper 11 and the outer periphery part 12b of the second damper 12 that are coupled to the voice coil 30 or the voice coil support part 31 are coupled to the frame 2, whereby even if a peel-off occurs at the coupling surface of either one of the first damper 11 and the second damper 12, the supporting force for the voice coil 30 can be maintained by the damper 10 for a speaker, thereby preventing the speaker device 1 from being damaged.

In the speaker device 1 shown in FIG. 8, the projecting height of the curved part 11c₁ on the side of the voice coil 30 is formed to be higher than the projecting height of the curved part on the side of the static part within a plurality of curved parts formed in the proximity of the inner periphery part of the damper 10 for a speaker. Further, the effective length of the curved part 11c₁ on the side of the voice coil 30 is formed to be larger than the valid length of the curved part on the side of the static part in the proximity of the curved part 11c₁. As such, when the voice coil 30 vibrates, a comparatively large stress is restrained from being applied on the connecting part between the damper 10 for a speaker and the voice coil 30, while allowing the damper 10 for a speaker to expand and contract following the vibration of the voice coil 30. Further, by making the projecting height of the curved part 11c₁ on the side of the voice coil 30 comparatively large, the curved part functions as a receiving part for the adhesive joining the voice coil 30 and the damper 10 for a speaker, whereby the coupling force of both connecting parts can be strengthened.

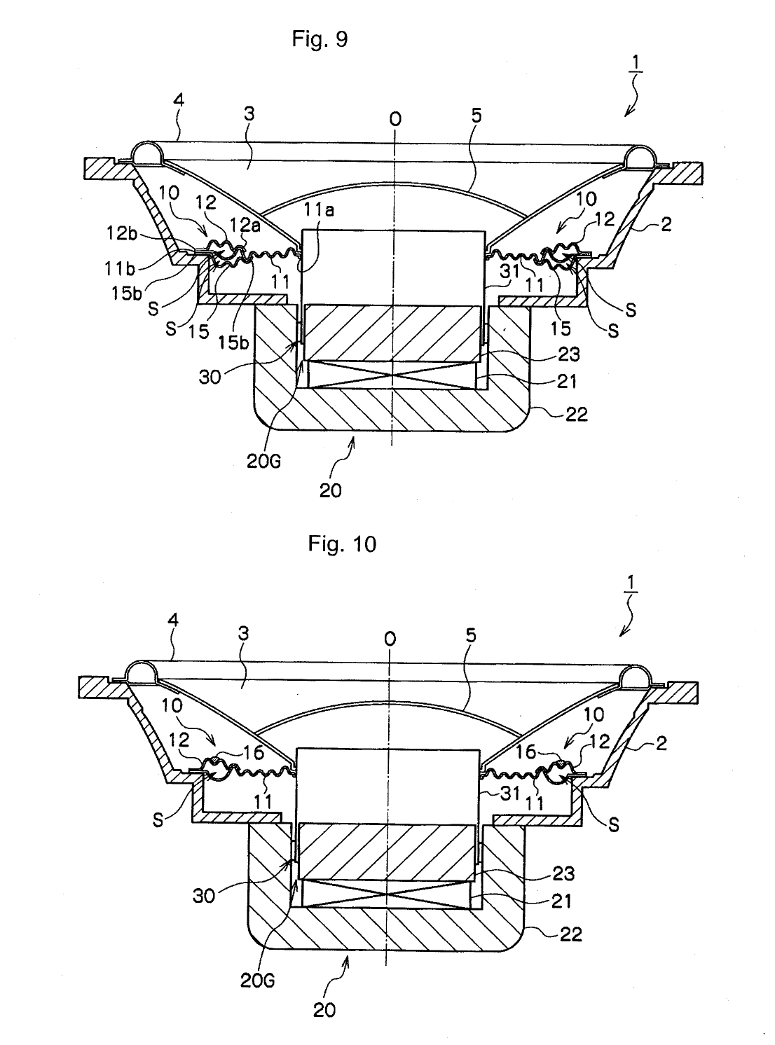

FIGS. 9 to 12 are views illustrating a variation of a speaker device equipped with a damper for a speaker according to an embodiment of the present invention (FIGS. 9 to 12 are cross-sectional view) (The same symbols are applied to the parts in common with the aforementioned embodiment and the descriptions are partially omitted).

In the example shown in FIG. 9, the damper 10 for a speaker in the speaker device 1 has the second damper 12 arranged on the upper side of the first damper 11, the third damper 15 is arranged on the lower side of the first damper 11, the outer periphery part 15b of the third damper 15 is connected to the outer periphery part 11b of the first damper 11, and the inner periphery part 15a of the third damper 15 is connected to the first damper 11 at the outer side of the inner periphery part 11a of the first damper 11. Specifically, the virtual curved top part of the second damper 12 is provided more on the outer periphery side and the virtual curve top part of the third damper is provided more on the inner periphery side than the curved top part of the first damper 11. Further the annular space S is formed between the first damper 11 and the second damper 12 as well as the third damper 15.

As such, the damper 10 for a speaker can be formed with a plurality of damper members. As shown in this example, by adding the third damper 15, more variations are available for adjusting the action of the damper 10 for a speaker when large amplitude of vibration is applies. Further, arbitrary adjustment is available in response to a request for symmetricity or asymmetricity of the vertical vibration of the voice coil 30. In the example of the drawing, the first damper 11, the second damper 12 and the third damper 15 have cross-sectional shapes different from each other. Each cross-sectional shape is arbitrarily determined in response to a request for the symmetricity or the asymmetricity of the vertical vibration of the voice coil 30 and so on. Further, the curved top part of the first damper, the virtual curved top part of the second damper, and the curved top part of the third damper may be provided at the positions different from each other, or they may be provided at the positions in the proximity of each other or substantially at the same positions.

The example shown in FIG. 10 illustrates a braking material 16 applied or laminated on the second damper 12 in the damper 10 for a speaker such that the resonance of the damper 10 for a speaker is restrained. The damping material 16 is a substance that has a high internal loss, including a damping material, polyamide system resin, polyurethane resin, thermostatic resin such as acryl system resin, foamable resin or SBR (styrene-butadiene rubber), NBR (nytril rubber), rubber material, resin film composed of the aforementioned resins and resin members having a foamable structure.

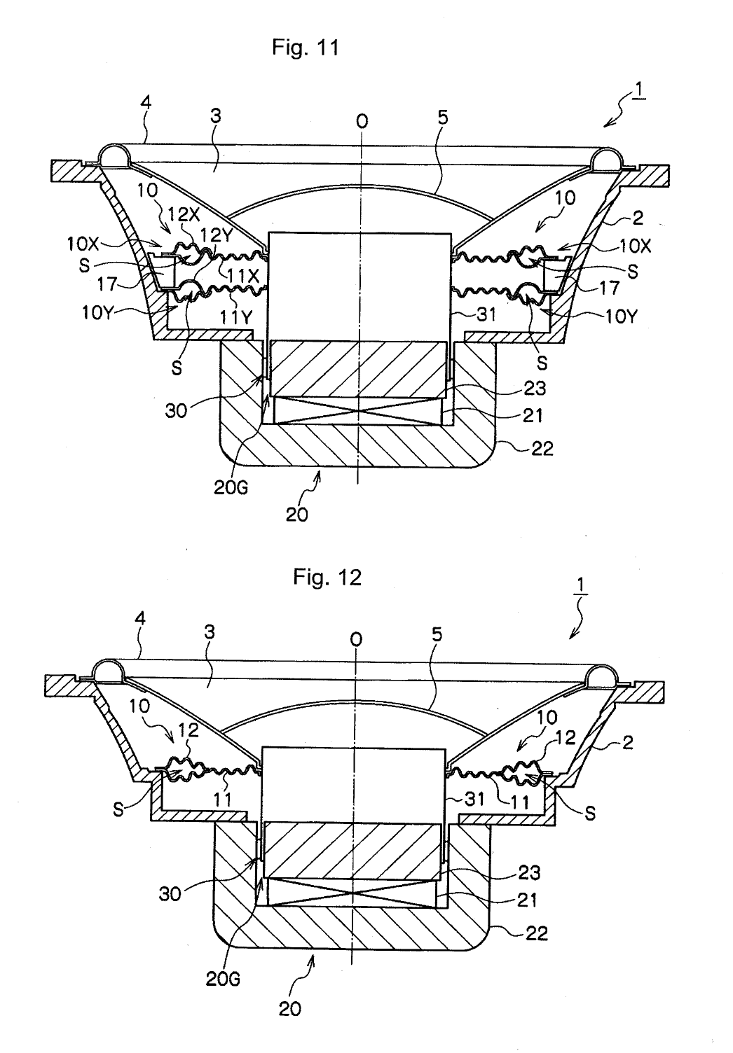

In the example shown in FIG. 11, the speaker device 1 includes a plurality of dampers 10 for a speaker. Here, the first damper 10 for a speaker X and the second damper 10 for a speaker Y are arranged in parallel in the vibration direction of the voice coil 30. The first damper 10 for a speaker X and the second damper 10 for a speaker Y include the first dampers 11X, 11Y and the second dampers 12X, 12Y respectively. Further, the dampers 10X, 10Y for a speaker are arranged to be substantially symmetrical with respect to a plane orthogonal to the vibration direction of the voice coil 30 respectively. That is, in the example shown in the drawing, the second damper 12X is connected on the upper side in the upper damper 10 for a speaker X and the second damper 12Y is connected on the lower side in the damper 10 for a speaker Y.

If a plurality of dampers 10 for a speaker are provided as described above, a holding force of the voice coil 30 can be strengthened, a rolling is restrained (vibration direction is more strongly controlled), braking performance is strengthened against the large amplitude of vibration being applied, a force applied to the damper 10 for a speaker in the manufacturing process is shared by a plurality of dampers, and the damper 10 for a speaker can be arranged at a given position. In the example shown in the drawing, the dampers 10X, 10Y for a speaker are attached to the frame side via a space member 17 as another member by attaching to the frame side at one time the space member 17 and the dampers 10X, 10Y for a speaker which are preliminarily attached the space member 17.

In the example shown in FIG. 12, a part of the first damper 11 opposing to the second damper 12 has a cross-sectional shape substantially symmetrical to the second damper 12 in the damper 10 for a speaker. Further, in the second damper 12, a first curved part having a large curvature diameter is arranged adjacently to a second curved part having a small curvature diameter and the first curved part includes a plurality of third curved parts having a small curvature diameter. Further a virtual curved top part of the first curved part is provided at a height different from the curved top part of the second curved part, that is, more on the sound emission side, and the top parts of the third curved parts are provided on the sound emission side more than the curved top part of the second curved part.

In the aforementioned embodiments except the example shown in FIG. 12, a part of the first damper 11 opposing to the second damper 12 has a cross-sectional shape different from the cross-sectional shape of the second damper. The cross-sectional shape of the second damper 12 or a part of the cross-sectional shape of the first damper 11 opposing to the second damper 12 can be formed to be symmetrical shape with respect to the center position of the first damper 11 (substantially line symmetrical shape or substantially point symmetrical shape), which is arbitrarily determined depending on the request for the symmetrical or asymmetrical property of the vertical vibration of the voice coil 30 and so forth.

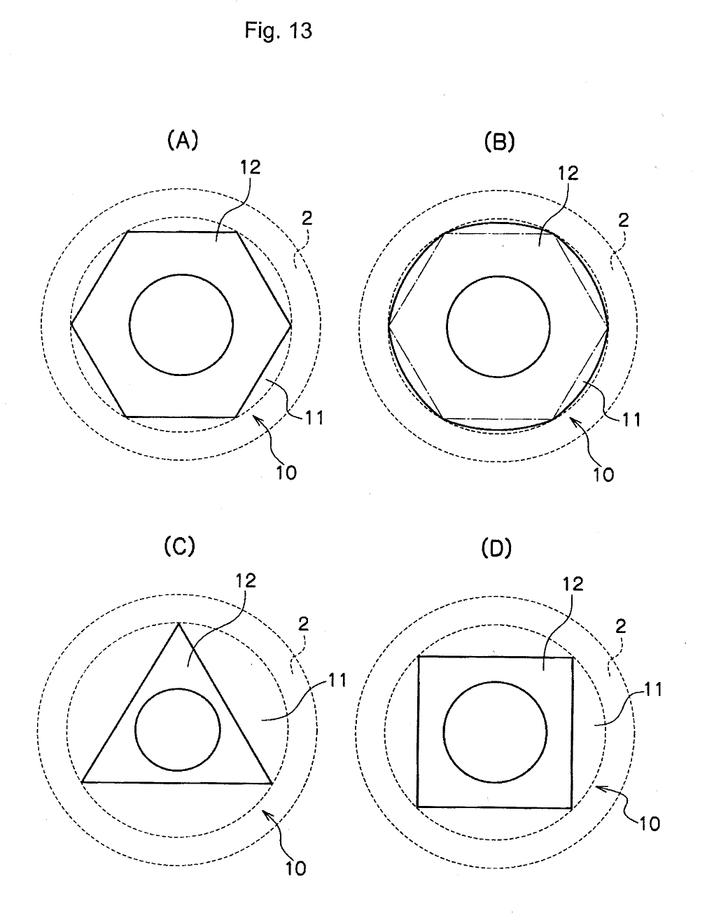

FIG. 13 is a view illustrating a planar shaped example of a damper for a speaker (schematic plan view). For one thing, the planar shape of the damper 10 for a speaker can be formed in accordance with the planar shape of the support part of a frame 2. However, the outer periphery parts of the first damper 11 and the second damper 12 which constitute the damper 10 for a speaker are not required to couple with the frame 2 around the entire circumference. In the example shown in FIG. 13, the planar shape of the second damper 12 that is joined to the outer periphery part of the damper 10 for a speaker is formed such that the outer periphery thereof has a plurality of top parts. In the example shown in FIG. 13(A), the outer periphery part is formed in a hexagonal shape and is supported by the frame 2 at each apex. In the example shown in FIG. 13(B), the outer periphery part is formed in a hexagonal shape and is supported by the frame 2 at each apex and each side of the outer periphery part is formed with a curved line. In the example shown in FIG. 13(C), the outer periphery part is formed in a triangular shape and is supported by the frame 2 at each apex. In the example shown in FIG. 13(D), the outer periphery part is formed in a rectangular shape and is supported by the frame 2 at each apex. In accordance with the configuration as described above, the resonance dispersion effect of the damper 10 for a speaker can be obtained. FIGS. 13(A), 13(B) and 13(D) show substantially line symmetrical cross-sectional shapes or point symmetrical cross-sectional shapes and FIG. 13(B) shows substantially point symmetrical cross-sectional shape.

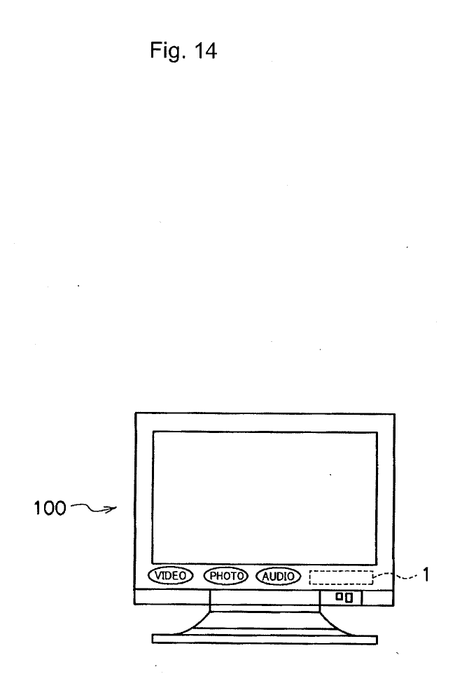

As describe above, the damper 10 for a speaker and the speaker device 1 according to an embodiment of the present invention can operate with both a high compliance and a low compliance and can achieve a high sound quality with a high linearity within the practical amplitude of vibration while producing loud sound. Such a speaker device can be used as a variety of electronic devices and in-car devices. FIG. 14 is a view illustrating an electronic device equipped with a speaker device according to an embodiment of the present invention. For example, the speaker device 1 can be attached to the inside of a cabinet as an attaching counterpart member an electronic device 100 such as a flat panel display includes.

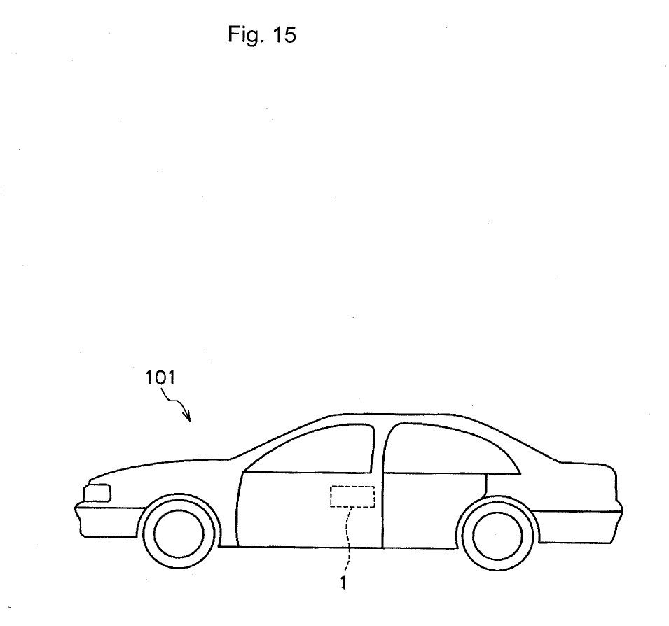

FIG. 15 is a view illustrating a vehicle equipped with the speaker device 1 including the damper 10 for a speaker according to an embodiment of the present invention. The speaker device 1 is attached to an attaching counterpart member such as a door, a front or rear tray of a vehicle 100 shown in FIG. 15 includes, and thereby enabling the achievement of both the high sound quality and the input resistance in a car audio device.

Further, when the speaker device 1 is mounted on the wall or ceiling as an attaching counterpart in buildings including a residential house (building) or a hotel, an inn, training facilities and so force (building), which can accommodate many guests for conferences, meetings, lectures, parties and so on, the speaker device 1 can produce loud sound with a high sound quality, and thereby enabling the achievement of residential space equipped with high-quality audiovisual facility.

The embodiments according to the present invention are described in detail with reference to the drawings, however specific configurations are not limited to these embodiments and any design alterations without departing from the scope of the present invention are included in the present invention. Further, the technologies of each embodiment as described above can be used by each other, unless specific contradictions or problems are involved in their objects, the configurations, and so forth.

1. A damper for a speaker for vibratably supporting a voice coil to a static part, the damper for a speaker comprising:
a first damper and a second damper formed in an annular shape having an inner periphery part and an outer periphery part respectively, the first and second dampers being formed in a shape expandable and contractable in a direction crossing a circumferential direction of the annular shape, wherein
said inner periphery part of said second damper is connected to said first damper between said inner periphery part and said outer periphery part of said first damper, and each outer periphery part of said first damper and said second damper is connected to each other such that annular space is formed between said first damper and said second damper; and
said first damper includes a plurality of expandable and contractable curved parts formed at least from a connecting point of said inner periphery part of said second damper to said inner periphery part of said first damper in a direction crossing said circumferential direction.

2. The damper for a speaker according to claim 1, wherein said second damper has higher rigidity than said first damper.

3. The damper for a speaker according to claim 2, wherein said first damper is continuously formed with a single member from said inner periphery part to said outer periphery part.

4. The damper for a speaker according to claim 3, wherein a plurality of expandable and contractable curved parts are formed in said second damper in a direction crossing said circumferential direction, and
a curvature diameter of said curved part on a side of said outer periphery part is larger than a curvature diameter of said curved part on a side of said inner periphery part in said plurality of curved parts which said first and second dampers include.

5. The damper for a speaker according to claim 4, wherein a cross-sectional shape of said second damper is formed in a protruding shape with a top part projecting from said inner periphery part and said outer periphery part.

6. The damper for a speaker according to claim 5, wherein the cross-sectional shape of said second damper includes a plurality of said top parts, and
a plurality of expandable and contractable curved parts are formed in said first damper from the connecting point with said inner periphery part of said second damper to said outer periphery part of said first damper in a direction crossing said circumferential direction.

7. The damper for a speaker according to claim 6, wherein said inner periphery part of said second damper is formed in accordance with a surface shape of said first damper.

8. The damper for a speaker according to claim 7, wherein said inner periphery part of said second damper is formed in a curved shape.

9. The damper for a speaker according to claim 8, wherein said second damper includes a first curved part having substantially an arc shaped cross-section and said first curved part includes a plurality of second curved parts having smaller curvature diameter than said first curved part.

10. The damper for a speaker according to claim 6, wherein said inner periphery part of said second damper is connected on the side of outer periphery part than a center position between said inner periphery part and said outer periphery part of said first damper.

11. The damper for a speaker according to claim 6, wherein said inner periphery part of said second damper is connected on the side of said inner periphery part than a center position between said inner periphery part and said outer periphery part of said first damper.

12. The damper for a speaker according to claim 6, wherein said inner periphery part of said second damper is connected near a center position between said inner periphery part and said outer periphery part of said first damper.

13. The damper for a speaker according to claim 9, wherein said inner periphery part of said second damper is located on a projecting side of said second damper with respect to said outer periphery part of said second damper.

14. The damper for a speaker according to claim 9, wherein said inner periphery part of said second damper is located on the side opposite a curved projecting side of said second damper with respect to said outer periphery part of said second damper.

15. The damper for a speaker according to claim 2, wherein both said first and second dampers are formed with a fibrous member, and
the fibrous member forming said second damper is larger in diameter than the fibrous member forming said first damper.

16. The damper for a speaker according to claim 2, wherein both said first and second dampers are formed with a fibrous member, and
the surface density of the fibrous member forming said second damper is higher than the surface density of the fibrous member forming said first damper.

17. The damper for a speaker according to claim 16, wherein the fibrous member forming said second damper has rigidity and a plurality of said fibrous members are restrained by adhesive resin.

18. The damper for a speaker according to claim 17, wherein said adhesive resin is phenol system resin.

19. The damper for a speaker according to claim 2, wherein a resin layer is continuously formed in proximity of a surface of said second damper.

20. The damper for a speaker according to claim 19, wherein said resin layer is continuously formed from said second damper to said first damper.

21. The damper for a speaker according to claim 20, wherein said resin layer covers a connecting part between said second damper and said first damper.

22. The damper for a speaker according to claim 21, wherein said connecting part is formed in a curved shape.

23. The damper for a speaker according to claim 17, wherein a resin layer is continuously formed in proximity of a surface of said second damper and an internal loss of the resin material forming said resin layer is larger than an internal loss of said adhesive resin said second damper has.

24. The damper for a speaker according to claim 1, wherein a part of said first damper opposing said second damper has a cross-sectional shape substantially symmetrical to a cross-sectional shape of said second damper.

25. The damper for a speaker according to claim 1, wherein said second damper is arranged on an upper side of said first damper and a third damper is arranged on a lower side of said first damper,
said outer periphery part of said third damper is connected to said outer periphery part of said first damper, and
said inner periphery part of said third damper is connected to said first damper at an outer side of said inner periphery part of said first damper.

26. The damper for a speaker according to claim 25, wherein said first damper, said second damper and said third damper have cross-sectional shapes different from each other.

27. The damper for a speaker according to claim 1, wherein said outer periphery part of a planar shape of said second damper has a plurality of apexes.

28. The damper for a speaker according to claim 2, wherein said first damper has a step in proximity of a connecting part where said first damper and said second damper are connected each other.

29. The damper for a speaker according to claim 28, wherein said inner periphery part of said second damper is formed in a folding back shape toward a sound emission direction.

30. A speaker device comprising the damper for a speaker described in claim 1, said static part including a magnetic circuit, and a vibrating body including said voice coil and supported by said static part.

31. The speaker device according to claim 30, wherein said inner periphery part of said damper for a speaker is connected to said voice coil and said outer periphery part of said damper is supported by said static part.

32. The speaker device according to claim 31, wherein a projecting height of the curved part on the side of said voice coil is formed to be higher than a projecting height of the curved part on the side of said static part within a plurality of said curved parts formed in proximity of said inner periphery part of the damper for a speaker.

33. The speaker device according to claim 32, wherein said static part includes a frame for supporting said magnetic circuit, and
said vibrating body includes a voice coil support part for supporting said voice coil, a diaphragm having said inner periphery part supported by said voice coil or said voice coil support part, and an edge for supporting said outer periphery part of said diaphragm to said static part, and
said magnetic circuit includes at least a magnet, a yoke and magnet space magnetic field lines crossing said voice coil pass through.

34. The speaker device according to claim 33, including a plurality of said dampers for a speaker.

35. The speaker device according to claim 34, wherein a plurality of said dampers for a speaker are arranged substantially symmetrically each other with respect to a plane surface orthogonal to the vibration direction of said voice coil.

36. A vehicle comprising the speaker device according to claim 30 and an attaching counterpart member.

37. An electronic device comprising the speaker device according to claim 30 and an attaching counterpart member.

38. A building comprising the speaker device according to claim 30 and an attaching counterpart member.
